(19) United States
(12) Patent Application Publication
(10) Pub. No.: US 2025/0200548 A1
(43) Pub. Date: Jun. 19, 2025

(54) AUTOMATED CONTEXT-BASED PAYMENT SELECTION

(71) Applicant: International Business Machines Corporation, Armonk, NY (US)

(72) Inventors: Su Liu, Austin, TX (US); Hamid Majdabadi, Ottawa (CA); Jeremy R. Fox, Georgetown, TX (US); Zachary A. Silverstein, Georgetown, TX (US)

(73) Assignee: International Business Machines Corporation, Armonk, NY (US)

(21) Appl. No.: 18/539,359

(22) Filed: Dec. 14, 2023

(51) Int. Cl. G06Q 20/22; H04L 67/306

(52) U.S. Cl. CPC G06Q 20/227; H04L 67/306

(57) ABSTRACT

A method for automatically selecting a payment method based on context is disclosed. In one embodiment, such a method includes establishing a user profile for a user. The user profile associates different payment methods with different categories of items. The method detects multiple items in a shopping cart of the user and automatically correlates the items in the shopping cart with the different categories in the user profile. In certain embodiments, automatically correlating includes using machine learning to automatically correlate the items in the shopping car with the different categories in the user profile. The method automatically assigns the different payment methods to the items in accordance with the categories to which the items have been correlated. A corresponding system and computer program product are also disclosed.

### BACKGROUND

### Field of the Invention

This invention relates generally to payment systems, and more specifically to systems and methods to automatically select a payment method based on context.

### Background of the Invention

Using different payment types (e.g., credit cards, debit cards, etc.) for different types of purchases can be advantageous. This may enable individuals to harness the specific advantages offered by each card, making their spending more efficient and rewarding. For instance, an individual may use a first credit card optimized for travel expenses when booking flights and hotels to maximize the accumulation of travel rewards, while turning to a second card with high cashback rates on groceries for everyday household shopping. This strategic use of credit cards or other payment types not only enhances one's ability to accumulate rewards like cashback, points, or miles, but also simplifies expense tracking (e.g., business verse personal expenses, or between different businesses) as it categorizes spending into specific areas.

Leveraging different credit cards or other payment types may also offer additional layers of security and protection. For example, some credit cards may come with built-in features such as purchase protection or extended warranties, which may be valuable when buying high-ticket items like electronics or appliances. By selecting the right credit card or other payment method for each purchase, individuals or entitles may ensure that they receive the most comprehensive benefits and safeguards for their particular needs, and/or that their finances and expense tracking are handled correctly.

### SUMMARY

The invention has been developed in response to the present state of the art and, in particular, in response to the problems and needs in the art that have not yet been fully solved by currently available systems and methods. Accordingly, systems and methods have been developed for automatically selecting payment methods based on context. The features and advantages of the invention will become more fully apparent from the following description and appended claims, or may be learned by practice of the invention as set forth hereinafter.

Consistent with the foregoing, a method for automatically selecting a payment method based on context is disclosed. In one embodiment, such a method includes establishing a user profile for a user. The user profile associates different payment methods with different categories of items. The method detects multiple items in a shopping cart of the user and automatically correlates the items in the shopping cart with the different categories in the user profile. In certain embodiments, automatically correlating includes using machine learning to automatically correlate the items in the shopping car with the different categories in the user profile. The method automatically assigns the different payment methods to the items in accordance with the categories to which the items have been correlated.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing one embodiment of a system in accordance with the invention;

FIG. 3 is a process flow diagram showing one embodiment of a method in accordance with the invention;

FIG. 4 is an example of a data and entity relationship diagram associated with a system in accordance with the invention; and

FIG. 5 is a process flow diagram showing one example of a use case in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 (i.e., a “context-aware cueing module 150”) for providing context-aware cueing for daily interactions, navigation, and accessibility. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

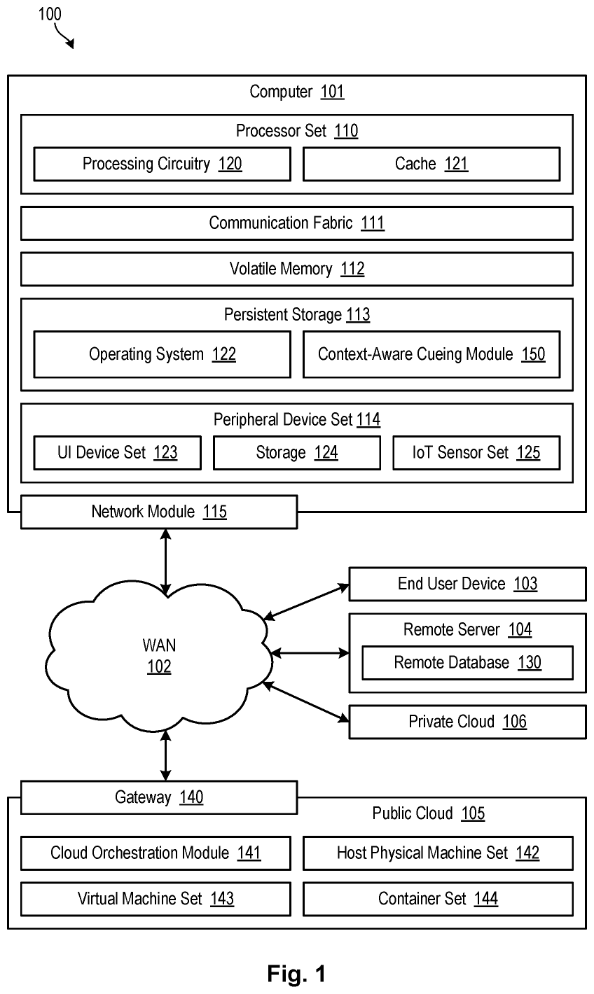

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

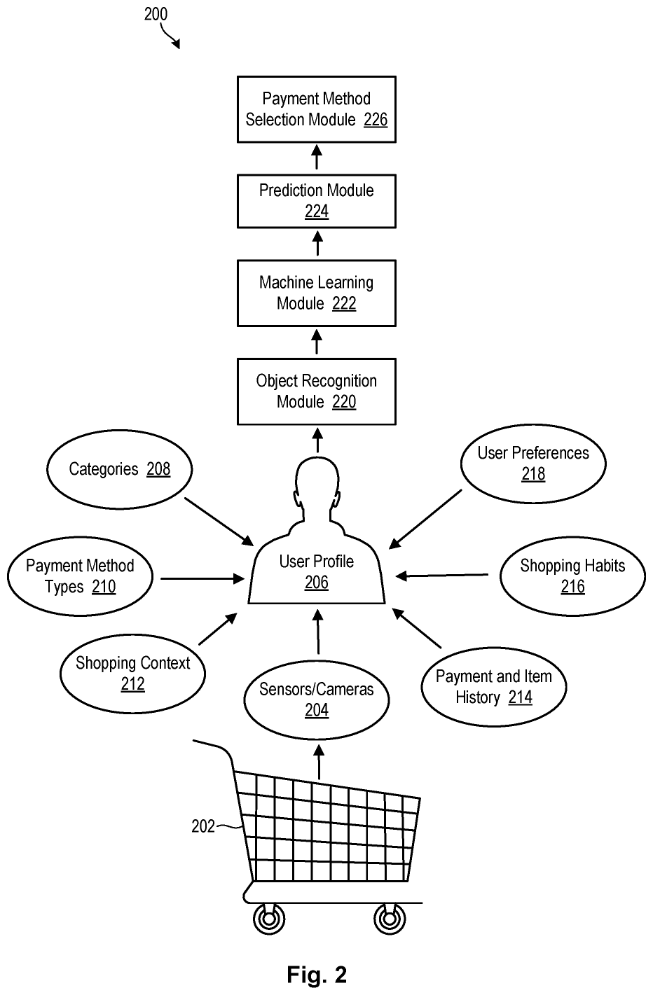

Referring to FIG. 2, as previously mentioned, using different payment methods (e.g., credit cards, debit cards, digital wallets, online payment systems etc.) for different types of purchases can be advantageous. This may enable individuals to harness the specific advantages offered by each payment method, making their spending more efficient and rewarding. For instance, an individual may use a first payment method optimized for travel expenses when booking flights and hotels to maximize the accumulation of travel rewards, while turning to a second payment method with high cashback rates on groceries for everyday household shopping. This strategic use of credit cards or other payment methods not only enhances one's ability to accumulate rewards like cashback, points, or miles, but also simplifies expense tracking (e.g., business verse personal expenses, or between different businesses) as it categorizes spending into specific areas.

Leveraging different payment methods may also offer additional layers of security and protection. For example, some credit cards may come with built-in features such as purchase protection or extended warranties, which can be valuable when buying high-ticket items like electronics or appliances. By selecting the right payment method for each purchase, individuals or entitles may ensure that they receive the most comprehensive benefits and safeguards for their particular needs, and/or that their finances and expense tracking are handled correctly.

As shown in FIG. 2, in certain embodiments in accordance with the invention, a system 200 may be provided to intelligently select payment methods based on context to enable and enhance automated checkout. In general, this may be accomplished by automatically detecting items placed into a shopping cart 202 (either real or virtual) of a user and automatically assigning payment methods to the items based on user preferences, payment and item history, shopping context, shopping habits, and/or the like. Much of this data may be stored in and/or associated with a user profile 206 of a user.

As shown, in certain embodiments, a shopping cart 202 may in certain embodiments be equipped with Internet-of-things (IoT) sensors/cameras 204 to detect items that are placed in the shopping cart 202. For example the sensors/cameras 204 may detect and scan a barcode or other identifier of the items, detect and scan the weight of the items, and/or identify the items in the shopping cart 202 using artificial intelligence that it trained to recognize the items (e.g., using image recognition). In certain embodiments, a combination of techniques may be used.

In certain embodiments, a user may establish various user preferences 218 that indicate the payment methods that the user utilizes, as well as the types and categories 208 of items the user wishes to associate with each of the payment methods. Payment methods may include, for example, specific credit cards, debit cards, digital wallets, online payment systems, or other payment method types 210. When an item is detected and identified in the shopping cart 202, the item may be associated with a particular shopping category 208 and thereby linked to the payment method that is associated with the category 208. In other embodiments, particular items may be linked to a payment method without having to be associated with a category 208.

In certain embodiments, the categories 208 are established by a user. In other embodiments, the categories 208 are established in accordance with some other criteria, such as commonly understood categories or classifications (e.g., household supplies, food, office supplies, health products, medicines, consumer devices, hardware, etc.). In some embodiments, a combination of both may be used.

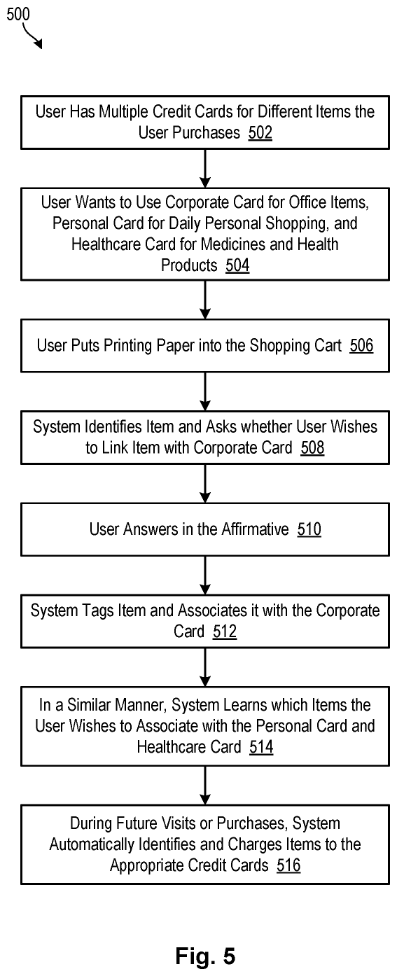

In certain embodiments, speech recognition technology may be used to indicate which payment methods to use for particular items or categories 208 of items. For example, at the time of checkout, a user may use the speech recognition technology to verbally indicate which payment method to use for an item that is being purchased, and/or to indicate which payment method to use for a category 208 that is associated with an item that is being purchased. One example of how this may be accomplished will be discussed in the use case of FIG. 5.

Other techniques may be used to associate particular payment methods with particular items or categories 208 of items. For example, shopping habits 216 or payment and item history 214 of the user may be analyzed by a machine learning module 222 to determine which payment methods the user typically or historically has used to purchase particular items or categories 208 of items. This may provide the basis for automatically using the same payment method when the user purchases these items or categories 208 of items again. In other embodiments, shopping context 212 may be considered by a machine learning module 222 in selecting a particular payment method. For example, a location, time of day, and/or date may be used in determining a payment method. For example, if the user is at an office supply store or is shopping during work hours, the system 200 may assume that items in the user's shopping cart 202 are for business purposes and select the user's business credit card for purchasing the items.

As shown in FIG. 2, once items are placed in the user's shopping cart 202, an object recognition module 220 may recognize and identify the items using the sensors/cameras 204 installed in or used in association with the shopping cart 202. In certain embodiments, the machine learning module 222 may assist in recognizing these items using machine learning algorithms. The machine learning module 222 may also learn the user's shopping habits 216 and payment and item history 214. The machine learning module 222 may in certain embodiments accomplish this using techniques such as data clustering (e.g., cluster analytics, hierarchical clustering, etc.) and input categorization (e.g., decision tree, random forest, support vector machine (SVM), etc.). In certain embodiments, a user profile 206 may be kept in JSON format, updated when a user interacts with the system 200, and combined with a preferred user interaction path of a vendor or application. Using the learning of the machine learning module 222, the prediction module 224 may predict which payment method(s) to use for items in a shopping cart 202. The payment method selection module 226 may then use the appropriate payment method(s) to complete the transaction(s).

If an item cannot be charged to a selected payment method, the user may in certain embodiments be notified to prevent errors and delays. Payment method information may be stored securely and only used for the purpose of charging items during the checkout process, thereby ensuring user privacy and data protection. In certain embodiments, users may be provided the option to opt-out of the intelligent payment method selection system 200 and manually charge items to different payment methods, thereby providing flexibility and choice.

The system 200 may be designed to comply with relevant data protection and privacy regulations to ensure user trust and confidence. The system 200 may also be continuously updated and improved based on user feedback and usage data to ensure optimal performance and user satisfaction. Retailers may in certain embodiments integrate the system 200 into their existing checkout process to enhance an overall shopping experience for their customers.

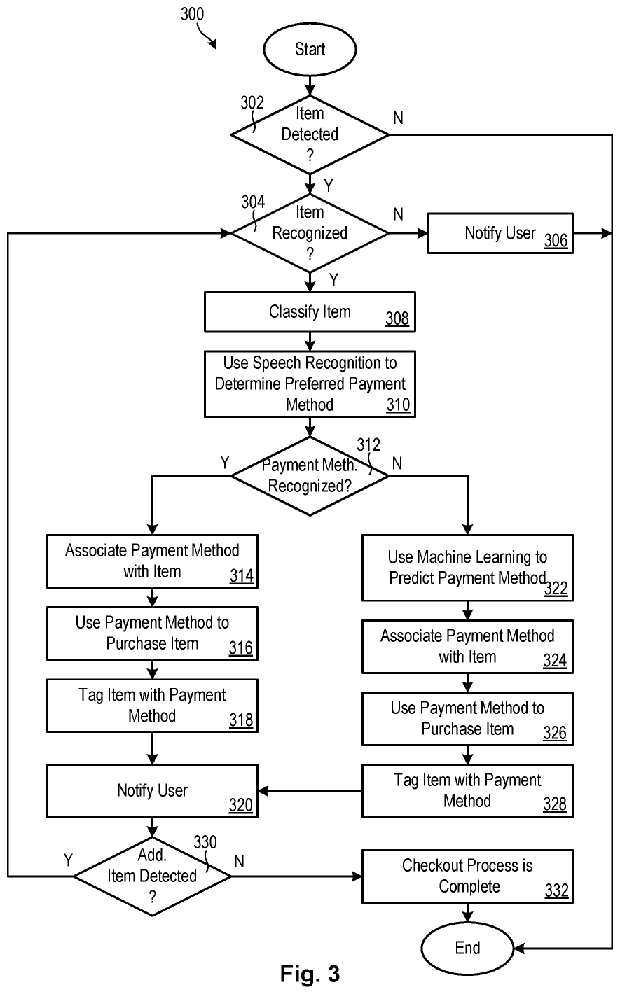

Referring to FIG. 3, a process flow diagram showing one embodiment of a method 300 for automatically selecting payment methods based on context is illustrated. This method 300 is presented by way of example and is not intended to be limiting. As shown, the method 300 initially determines 302 whether an item has been detected in a user's shopping cart 202. If not, the method 300 ends. If so, the method 300 determines 304 whether the item is recognized. If not, the method 300 notifies 306 the user that the item is not recognized. This may potentially enable the user to identify the item so that the system 200 is able to recognize and identify the item in the future.

If the item is recognized 312, the method 300 may in certain embodiments classify 308 the item into one or more of the categories 208 previously discussed. In certain embodiments, the method 300 uses 310 speech recognition technology to determine a preferred payment method to use for the item and/or the category 208 to which the item belongs. If the payment method is recognized by the system 200, the method 300 automatically associates 314 the payment method with the item and uses 316 the payment method to purchase the item, or queues the item for eventual purchase with the payment method. The method 300 may also tag 318 the item with the payment method and notify 320 the user that the payment has been completed successfully or that the item has been queued successfully for purchase with the payment method.

If the method 300 does not recognize 312 the payment method, the method 300 may use 322 machine learning to predict the payment method to use to purchase the item. This may be based on shopping habits 216, payment and item history 214, shopping context 212, and/or the like. The method 300 associates 324 the payment method with the item and uses 326 the payment method to purchase the item or queues the item for eventual purchase with the payment method (such as at the end of a checkout process). The method 300 may also tag 328 the item with the payment method and notify 320 the user that the payment has been completed successfully or that the item has been successfully queued for purchase with the payment method.

At this point, the method 300 may determine 330 whether additional items are detected in the user's shopping cart 202 and repeat the method 300 for any additional items. At this point, the checkout process may be complete at step 332 and the method 300 may end.

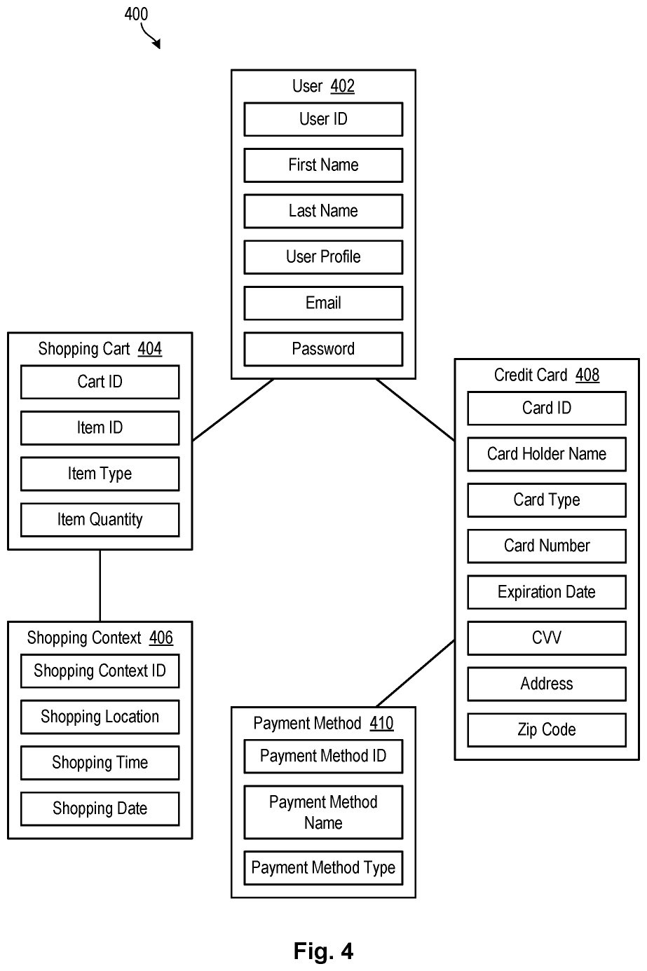

Referring to FIG. 4, one example of a data and entity relationship diagram 400 associated with a system 200 in accordance with the invention is illustrated. This data and entity relationship diagram 400 is presented by way of example and not limitation and may not represent an exhaustive list of all data and entities in a system 200. The data and entities may also be organized differently in different embodiments.

As shown, entities (e.g., objects) may, in certain embodiments, include a user 402. The user 402 may include attributes such as user ID, first name, last name, user profile 206, email, password, and the like. The user 402 may be associated with a credit card 408, which may have attributes such as card ID, card holder name, card type, card number, expiration data, card verification value (CVV) code, address, zip code, and the like. The credit card 408 may be a particular payment method 410. This payment method 410 may have attributes including payment method ID, payment method name, payment method type, and the like.

The user 402 have also have a shopping cart entity 404 associated therewith. This shopping cart entity 404 may have attributes that include a cart ID, item IDs, item types (e.g., categories), and item quantities. The shopping cart entity 404 may be associated with a particular shopping context 406, which may include attributes such as shopping context ID, shopping location, shopping time, shopping data, and the like.

Referring to FIG. 5, a process flow diagram showing one example of a use case 500 in accordance with the invention is illustrated. This use case 500 is presented by way of example and not limitation. As shown, the use case 500 assumes 502 that a user has multiple credit cards for different items that the user purchases. In this use case 500, the user wishes 504 to use a corporate credit card for office items, a personal credit card for daily personal shopping, and a healthcare card for medicines and health products.

In the illustrated use case 500, the user puts 506 printing paper into the user's shopping cart 202. The system 200 identifies 508 the item and asks 508 (e.g., either audibly or by showing on a display or other output device) the user whether the user would like to link the item with the user's corporate credit card. In this example, the user answers 510 in the affirmative (e.g., either by speaking or by selecting on a display or other input device) and the system 200 tags 512 the item and associates 512 it with the user's corporate credit card. In a similar manner, the system 200 learns 514 which items the user wishes to associate with the user's personal credit card and the user's healthcare credit card. During future visits or purchases, the system 200 automatically identifies 516 and charges 516 items to the appropriate credit cards.

Different variations or enhancements of the system 200 are possible. For example, in certain embodiments, the system 200 may enable users to set spending limits for different categories of items. That it, users may specify how much they are willing to spend on each item or category 208 of items and the system will automatically charge the appropriate payment method only up to the specified spending limit. This feature may assist users in better managing their personal budgets and ensure that they are not overspending on specific items or categories 208. Users may in certain embodiments view and modify their spending limits before completing the checkout process, thereby allowing them to autonomously “manage” without active actions. This may provide users with more control over their spending and help to ensure that they are not exceeding their budgets.

The disclosed system 200 may offer significant benefits for both retailers and customers, making the shopping experience more convenient and efficient. These benefits may include: convenience wherein users may quickly and easily purchase items without having to wait in line at a checkout counter; accuracy since the system 200 may reduce the risk of human error in the checkout process and ensure that customers are charged the correct amount for their purchases; cost savings to enable retailers to save on labor costs by reducing the number of checkout counters and cashiers needed in their stores; and enhanced customer experience by providing a faster and more convenient checkout process to enable retailers to improve the overall shopping experience for their customers.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for automatically selecting a payment method based on context, the method comprising:
establishing a user profile for a user, the user profile associating different payment methods with different categories of items;
detecting a plurality of items in a shopping cart of the user;
automatically correlating the items in the shopping cart with the different categories in the user profile; and
automatically assigning the different payment methods to the items in accordance with the categories to which the items have been correlated.

2. The method of claim 1, wherein automatically correlating comprises using machine learning to automatically correlate the items in the shopping car with the different categories in the user profile.

3. The method of claim 1, further comprising using machine learning to identify the items in the shopping cart.

4. The method of claim 3, further comprising using at least one of IoT sensors and cameras to identify the items in the shopping cart.

5. The method of claim 1, wherein the different payment methods comprise at least one of credit cards and debit cards.

6. The method of claim 1, further comprising using machine learning to analyze at least one of a shopping history, shopping context, and preferences of the user in order to identify the categories and associated payment methods.

7. The method of claim 1, wherein the shopping cart is a physical shopping cart.

8. A computer program product for automatically selecting a payment method based on context, the computer program product comprising a computer-readable storage medium having computer-usable program code embodied therein, the computer-usable program code configured to perform the following when executed by at least one processor:
establish a user profile for a user, the user profile associating different payment methods with different categories of items;
detect a plurality of items in a shopping cart of the user;
automatically correlate the items in the shopping cart with the different categories in the user profile; and
automatically assign the different payment methods to the items in accordance with the categories to which the items have been correlated.

9. The computer program product of claim 8, wherein automatically correlating comprises using machine learning to automatically correlate the items in the shopping car with the different categories in the user profile.

10. The computer program product of claim 8, wherein the computer-usable program code is further configured to use machine learning to identify the items in the shopping cart.

11. The computer program product of claim 10, wherein the computer-usable program code is further configured to use at least one of IoT sensors and cameras to identify the items in the shopping cart.

12. The computer program product of claim 8, wherein the different payment methods comprise at least one of credit cards and debit cards.

13. The computer program product of claim 8, wherein the computer-usable program code is further configured to use machine learning to analyze at least one of a shopping history and preferences of the user in order to identify the categories and associated payment methods.

14. The computer program product of claim 8, wherein the shopping cart is a physical shopping cart.

15. A system for automatically selecting a payment method based on context, the system comprising:
at least one processor;
at least one memory device operably coupled to the at least one processor and storing instructions for execution on the at least one processor, the instructions causing the at least one processor to:
establish a user profile for a user, the user profile associating different payment methods with different categories of items;
detect a plurality of items in a shopping cart of the user;
automatically correlate the items in the shopping cart with the different categories in the user profile; and
automatically assign the different payment methods to the items in accordance with the categories to which the items have been correlated.

16. The system of claim 15, wherein automatically correlating comprises using machine learning to automatically correlate the items in the shopping car with the different categories in the user profile.

17. The system of claim 15, wherein the instructions further cause the at least one processor to use machine learning to identify the items in the shopping cart.

18. The system of claim 17, wherein the instructions further cause the at least one processor to use at least one of IoT sensors and cameras to identify the items in the shopping cart.

19. The system of claim 15, wherein the different payment methods comprise at least one of credit cards and debit cards.

20. The system of claim 15, wherein the instructions further cause the at least one processor to use machine learning to analyze at least one of a shopping history and preferences of the user in order to identify the categories and associated payment methods.
